(19) United States
(12) Patent Application Publication
(10) Pub. No.: US 2009/0160175 A1
(43) Pub. Date: Jun. 25, 2009

(54) Advertisement Medium

(76) Inventor: Eijiro Tomomori, Tokyo (JP)

Correspondence Address: RISSMAN HENDRICKS & OLIVERIO, LLP, 100 Cambridge Street, Suite 2101, BOSTON, MA, 02114, US

(21) Appl. No.: 11/776,698

(22) Filed: Jul. 12, 2007

(51) Int. Cl. B42D 15/00

(52) U.S. Cl. 283/56

(57) ABSTRACT

To provide an advertisement medium capable of firmly conveying advertisement information to a person in need, a public needing the advertisement information by providing the advertisement information to individuals with pinpoint accuracy only for a public who are closely related to information of a product or the like constituting an object of the advertisement, the advertisement medium for being provided to respective individuals who are receivers of the advertisement information includes a stereoscopic image display portion capable of displaying the advertisement information and a spectacles portion capable of optically recognizing stereoscopically an image displayed on the stereoscopic image display portion

### BACKGROUND OF THE INVENTION

1. Field of the Invention

The present invention relates to an advertisement medium, particularly relates to an advertisement medium capable of firmly conveying advertisement information to individuals needing the advertisement information.

2. Description of the Related Art

Currently, advertisements by various enterprises or the like are carried out by utilizing mass media of television, newspapers, magazines or the like.

Mass media can widely transmit various information to a number of viewers/listeners, readers, and therefore, also in advertisements, there is a possibility that the advertisements attract attention of a number of viewers/listeners, conventionally, enterprises or the like carry out advertisements utilizing mass media.

However, in advertisements utilizing such mass media, there poses a problem shown below in a related art.

Mass media are media constituting an object by general public, and therefore, also advertisements utilizing mass media advertise widely to a number of unspecified public, and the object of the viewer/listener, reader or the like cannot be narrowed down to receivers of specific information. In this case, although there are also media narrowing down readers constituting an object of a specialized magazine, the object is constituted by a large number of readers.

Therefore, advertisements are provided uniformly not only to readers and viewers/listeners interested in information of products or the like related to the advertisements but also readers and viewers/listeners who are not interested in products or the like related to advertisements, and therefore, a possibility of amounting to purchase the products by consumers by advertisements in mass media is very low when compared with scales of advertisements.

Further, when advertisements are carried out in the mass media, advertisement fees paid to owners of mass media of television companies, newspaper companies, magazine companies or the like are very high and when invested sums of advertisement fees are taken into a consideration, there is frequently a case in which from a view point of expense versus effect, a sufficient advertisement effect cannot be achieved.

Further, all of advertisements by the mass media is so-to-speak one shot information from a view point of a possibility of attracting attention of viewers/listeners, readers, particularly, with regard to television, even when viewers/listeners look at the commercials by television, in consideration of a current state in which a number of commercials are carried out, a possibility that only a specific commercial remains in impression of viewers/listeners is very low.

Similarly, also in newspapers, magazines or the like, there is present a situation that a possibility that a reader firmly reaches a specific advertisement in a number of pages of a number of descriptions is very low, in consideration of the fact that the advertisement fee is very high, similar to television, from a view point of expense versus effect, there is frequently a case in which the effectiveness of the advertisement is doubtful.

On the other hand, in recent years, the internet has been spread, and therefore, various advertisements can be carried out on homepages by utilizing the internet, and respective companies advertise products of their own companies on homepages. In such an advertisements, an advertisement fee is dispensed with, and therefore, there is not a drawback in cases of mass media of related arts as described above.

However, in order to survey the homepages by general public, a computer needs to be purchased and used and access needs to make to the homepages, and therefore, there is frequently a case in which only a person interested in the company or product beforehand views an actual advertisement and there is a present a drawback that a problem is posed in convenience of conveying information of advertisements.

Further, although advertisement information can be conveyed to individuals directly by direct mail, it is difficult to narrow down precisely destinations of direct mail and the advertisement effect cannot be expected so much similar to the above-described.

The present invention has been carried out in view of the problems of the related arts and provides advertisement medium capable of conveying advertisement information firmly to persons in need, public who need the advertisement information by providing the advertisement information for respective individuals with pinpoint accuracy of only public closely related to information of products or the like constituting an object of the advertisements.

Although the applicant has surveyed past references from such a view point, related references cannot be discovered.

### SUMMARY OF THE INVENTION

In order to resolve the above-described problem, according to the invention described in Claim 1, there is provided an advertisement medium for being provided to respective individuals being receivers of the advertisement information comprising a stereoscopic image display portion capable of displaying a piece of advertisement information, and a spectacles portion capable of optically recognizing stereoscopically an image displayed on the stereoscopic image display portion

Therefore, according to the invention described in Claim 1, respective individuals provided with the advertisement medium receive the piece of advertisement information by way of the stereoscopic image by optically recognizing the stereoscopic image by the spectacles portion.

Further, there is a case in which the advertisement medium is directly delivered to the individual who is a receiver of the piece of information, or a case in which the advertisement medium is mailed thereto, and any method can be used for a method of providing the advertisement medium to individuals.

According to the invention described in Claim 2, the advertisement medium is formed by a size capable of being distributed to the respective individuals who are the receivers of the piece of information and a weight capable of ordinarily being used by the respective individuals and formed foldably.

Therefore, according to the invention described in Claim 2, the advertisement medium is provided to respective individuals who are receivers of the piece of information easily by various modes and respective individuals obtaining the advertisement medium can handily use the advertisement information to recognize.

According to the invention described in Claim 3, the advertisement medium per se is formed to be able to be sent by mail.

Therefore, according to the invention described in Claim 3, the advertisement medium is made to be provided to individuals as the medium per se.

According to the invention described in Claim 4, the advertisement medium comprises an advertisement medium main body and a stereoscopic image sheet displayed on the stereoscopic image display portion of an advertisement medium main body.

Therefore, according to the invention described in Claim 4, the stereoscopic image display portion is attached with the stereoscopic image sheet provided separately from the advertisement medium main body to form the stereoscopic image.

According to the invention described in Claim 5, the stereoscopic image sheet comprises a plurality of sheets and is fixed to the stereoscopic image display portion attachably thereto and detachably therefrom.

Therefore, according to the invention described in Claim 5, various stereoscopic images can be formed by respectively attaching to interchange the plurality of sheets of stereoscopic image sheets to the stereoscopic image display portion of the advertisement medium main body.

According to the invention described in Claim 6, the stereoscopic image display portion and the spectacles portion are provided at one sheet of a plate-like member and the stereoscopic image display portion and the spectacles portion are folded to be erected and used by being arranged to be able to be opposed to each other.

Therefore, according to the invention described in Claim 6, the stereoscopic image display portion and the spectacles portion are provided to respective individuals as the plate-like member and individuals provided with the plate-like member erect the stereoscopic image display portion and the spectacles portion to be used.

According to the invention described in Claim 7, a total of the plate-like member is formed by a rectangular shape and the stereoscopic image display portion and the spectacles portion are arranged at both end portions in a length direction thereof.

According to the invention described in Claim 8, the stereoscopic image display portions are formed at both of a surface side and a rear face side of the plate-like member and the stereoscopic image display portion and the spectacles portion are constituted to be able to be used even when the stereoscopic image display portion and the spectacles portion are folded to bend in a direction of the rear face.

According to the invention described in Claim 9, the stereoscopic image display portion is displayed with a hole stereoscopic photograph showing sceneries of viewing greens of respective holes of a golf course from a visual point of a player and hole perspective views showing layouts of the holes in correspondence with each other.

The invention according to Claim 9 related to a case in which the advertisement medium according to the invention is distributed in a golf tournament, or applied to an advertisement medium sold at the golf course, and the hole stereoscopic photograph and the hole perspective view are displayed as the stereoscopic image display portion.

Therefore, according to the invention described in Claim 9, a golfer obtaining the advertisement medium according to the claim can image the actually holes by looking at the hole stereoscopic photographs showing the sceneries of viewing the greens of the respective holes in the golf course from a visual point of a player, and can investigate an effective method of attacking the holes by viewing the hole perspective views before actually standing on the course.

According to the invention described in Claim 10, a golf score card is displayed between the stereoscopic image display portion and the spectacles portion.

Therefore, according to the invention described in Claim 10, when the advertisement medium is obtained, for example, in a case of viewing a golf tournament, while going along a professional golfer for whom the golfer per se is a fan, the score of the play can be recorded. Further, when the golfer per se plays, the score of the player per se can also be described.

According to the invention described in Claim 11, the hole perspective view shows fly distances in the hole of respective professional golfers.

Therefore, according to the invention described in Claim 11, when the advertisement medium is obtained, a method of attacking the hole can be conceived in reference to the fly distances of the holes of the respective professional golfers shown in the perspective photographs.

According to the invention described in Claim 12, the hole stereoscopic photograph displayed on the stereoscopic image display portion is formed to be able to optically recognize an undulation of a ground surface of the green of the photographed hole.

Therefore, according to the invention described in Claim 12, when the advertisement medium according to the invention is used, a user of the advertisement medium according to the invention can grasp beforehand the undulations of the greens of the respective holes.

According to the invention described in Claim 13, the hole stereoscopic photographs and the hole perspective views displayed on the stereoscopic image display portion are formed by 18 sheets of photographs by individually taking images of 18 holes forming the golf course and are fixed to the stereoscopic image display portion attachably thereto and detachably therefrom.

Therefore, when the advertisement medium according to the invention described in Claim 13 is used, the golfer can optically experience all of the holes constituting the golf course beforehand and investigate a method of attacking the respective holes beforehand.

According to the invention described in Claim 1, different from an advertisement utilizing mass media which is carried conventionally, the advertisement medium is directly provided to the individual who is closely related to the piece of information according to the advertisement and who needs to obtain the information.

As a result, by providing the piece of information to respective individuals with pinpoint accuracy for only a public who are closely related to information of a product or the like constituting an object of the advertisement, the advertisement medium capable of firmly conveying the advertisement information can firmly be conveyed to a person in need or a public needing the advertisement information.

Therefore, the advertisement information can be conveyed under a situation in which the side of the advertisement and the side of the receiver of the advertisement information are brought into a state of one person versus one person, that is, ‘one-to-one’, and therefore, in comparison with a case of an advertisement utilizing mass media, the advertisement information can firmly be provided directly to a consumer, or an individual who is a person in need needing the information, and therefore, the advertisement effect can considerably be promoted.

Further, since mass media are not utilized, the advertisement fee can be reduced, and an efficiency of an expense of the advertisement can considerably be improved.

Further, according to the advertisement medium of the invention, individuals obtaining the advertisement medium can recognize the advertisement object by the stereoscopic image, and therefore, in comparison with a case of a general displayed advertisement, the advertisement information enriched with a further real feeling of presence having an impact can be received.

According to the invention described in Claim 2, the advertisement medium can be provided to respective individuals who are receivers of information easily by various modes, and therefore, a possibility of utilizing the advertisement medium can be made to be wide. Further, respective individuals obtaining the advertisement medium can handily use the advertisement medium to recognize the advertisement information, and therefore, also an access to the advertisement information is easy, and the firm advertisement effect can be achieved.

According to the invention described in Claim 3, the advertisement medium can also be used as a further effective direct mail.

According to the invention described in Claim 4, the advertisement medium is constituted such that the stereoscopic image is drawn on the stereoscopic image sheet provided separately from the advertisement medium main body, the stereoscopic image sheet is attached to the advertisement medium main body, and is optically recognized from the spectacles portion to thereby form the stereoscopic image, and therefore, the advertisement medium main body and the stereoscopic image sheet can be provided or sold separately from each other to provide to the receiver of the information.

According to the invention described in Claim 5, various stereoscopic images can be formed by using the plurality of sheets of stereoscopic image sheets on one piece of the advertisement medium main body.

According to the invention described in Claim 6 through claim 8, the advertisement medium is formed by one sheet of the plate-like member, and therefore, the advertisement medium is excellent in carrying performance, can be easily provided to respective individuals who are receivers of the information, and excellent in handling performance, preserving performance for sides of individuals provided therewith, and therefore, the firm advertisement effect can be achieved.

Further, also a person in need provided therewith can use the advertisement medium by folding to bend to erect the stereoscopic image display portion and the spectacles portion, and therefore, use thereof is easy, and the advertisement information can be provided by optically recognizing firmly the advertisement object.

Therefore, for example, when the advertisement medium is provided to respective individuals who are receiver of the information of the advertisement medium according to the invention, the advertisement medium is sold or distributed by being packed in a state of one sheet of a flat plate-like member, when respective individuals use the advertisement medium, the advertisement medium can be used by erecting the stereoscopic photograph portion and the spectacles portion to be brought into a state of being able to use as the stereoscopic spectacles.

As a result, when the advertisement medium is carried, preserved and sold as a commodity, since the advertisement medium is one sheet of the plate-like member, the advertisement medium is easy to be handled, carrying cost, preserving cost can be reduced, and also when the advertisement medium is packed in selling the advertisement medium, handling thereof is facilitated.

According to the invention described in Claim 8, the advertisement object can be displayed on both of the surface side and the rear side of the plate-like member, and therefore, a plurality of kinds of advertisements are carried out, and the advertisement medium can efficiently be used.

According to the invention described in Claims 9 through 13, the advertisement medium according to the invention is applied to a case of being utilized for an advertisement related to golf and use thereof enriched in a variety can be carried out.

For example, when the advertisement medium according to the invention is distributed to a visitor as a novelty free of charge, or when the advertisement medium is distributed with a charge in place of an admission ticket, a stereoscopic photograph of a commodity of a sponsor enterprise of the tournament can be displayed on the advertisement display portion.

As a result, in the above-described case, the advertisement medium according to the invention can be used effectively as the advertisement medium of an enterprise constituting the tournament sponsor.

Further, the advertisement medium according to the invention can be sold in place of the score card to carry out the advertisement at a golf course and an individual constituting a golfer constituting a purchaser and a receiver of the information of the advertisement medium can also use the advertisement medium as a golf goods used for a practice of the individual per se.

As a result, the advertisement medium can be made to utilize for use of not only the advertisement effect but also for individuals who are receivers of the advertisement information for a use other than the advertisement, when used, the individuals look at the advertisement simultaneously, and therefore, also the advertisement does not constitute one shot information for a person in need, a consumer, the advertisement effect can repeatedly be achieved, and the advertisement effect can further be enhanced.

When the advertisement medium described in the claim is used for a golf training of a golfer per se, the golfer can simulatingly experience optically a hole by peeping the hole displayed on the stereoscopic image display portion through the spectacles portion, and therefore, before going out the actual golf course, a method of attacking the hole can be investigated beforehand and the image training can repeatedly be carried out.

That is, in order to improve the score in the golf play, ‘what shot is to be carried out by what line of a ball and to which place’ constitutes the most important factor. For that purpose, investigation of the individual holes beforehand becomes indispensable, according to the invention described in Claims 9 through 13, a simulation beforehand can be carried out by using the advertisement medium, when actually going to a golf course, it is not necessary to worry about an attacking method within a short period of time at cites of respective holes, the golf course can easily be attacked, the score can be improved.

Further, by looking at a hole stereoscopic photograph showing a scenery of viewing a green of a specific hole from a visual point of a player at the stereoscopic image display portion, the scenery of the hole can stereoscopically be grasped by a screen having a depth by the stereoscopic photograph of the actual specific hole. Further, by looking at the hole perspective views, the total shapes of the respective holes can perspectively be recognized, and the method of attacking the course can also be studied and therefore, the skill of the golf of the golfer per se can be promoted.

That is, by optically recognizing the hole stereoscopic photograph and the course perspective photograph, the investigation with regard to by what angle and in which direction the shot is to be carried out in the hole can be carried out by substantially complete image training, and therefore, the score can be improved further easily.

In the golf, importance of the image training has been pointed out, according to the invention, other than the image training of a golf swing and image training of attitude in shooting, the method of attacking the respective holes of the course can be established by effectively carrying out a virtual simulation by using the stereoscopic image.

According to the invention described in Claim 10, for example, when a golf tournament is viewed, by going along a professional golfer for whom the golfer is a fan, the score of the play can be recorded. Further, when the golfer per se carries to use the score card when the golfer per se plays, the score of the golfer per se can also be described.

According to the invention described in Claim 11, an owner of the advertisement medium can confirm and refer to the fly distance of the famous professional golfer at the hole when the hole perspective view is viewed, a comparative investigation can be carried out in comparison with a fly distance of a shot of the golfer per se, and a target of the golf play of the golfer per se can be constituted, and the taste for the golf can further be promoted.

According to the invention described in Claim 12, the stereoscopic photograph of the hole displayed on the stereoscopic image display portion is formed to be able to optically recognize the undulation of the ground surface of the green of the hole, and therefore, when viewed from the spectacles portion, the surface of the hole can stereoscopically be viewed to be able to excellently recognize the undulation, and therefore, the hole can be experienced really as if the golfer were looking at the hole by standing at the hole.

Therefore, when the image training is carried out, there is the feeling of presence, and therefore, the golfer can carry out the image training further seriously, and effect of the image training is enhanced. As a result, in putting on the actual green, such effect of the training beforehand can be made to subject to full use.

According to the invention described in Claim 13, the golfer can optically experience all of the holes constituting the golf course, the method of attacking the respective holes can be investigated beforehand, and therefore, by utilizing the advertisement medium according to the invention, the score can easily be improved.

### BRIEF DESCRIPTION OF THE DRAWINGS

FIG. 1 shows an embodiment of an advertisement medium according to the invention and is a perspective view showing a state of use;

FIG. 2 shows an embodiment of a golf good according to the invention and is a perspective view showing a state of making the state of use upside down; and

FIG. 3 shows the embodiment of the advertisement medium according to the invention and is a perspective view in a state of being provided in a developed state.

### DETAILED DESCRIPTION OF THE PREFERRED EMBODIMENT(S)

An explanation will be given of an applied example of a case of distributing an advertisement medium related to the invention to a gallery of a golf tournament by a sponsor as the advertisement medium in the tournament in reference to attached drawings as follows.

As a premise, an advertisement medium 11 according to the embodiment is used by a sponsor enterprise of a golf tournament as the advertisement medium in the tournament and is distributed to a gallery of viewing the tournament in exchange for a fee by a side of the sponsor of the tournament in opening the tournament.

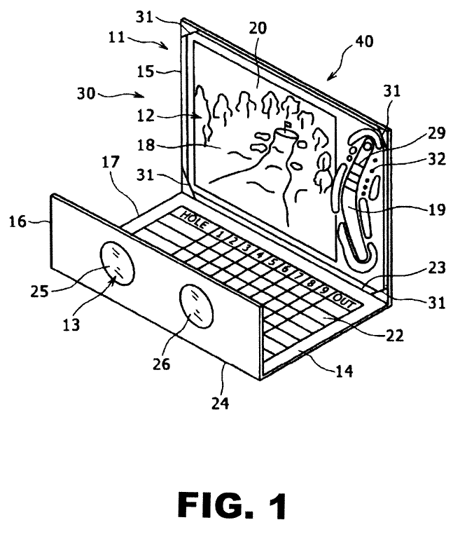

As shown by FIG. 1, the advertisement medium 11 according to the embodiment is constituted by an advertisement medium main body 40, and a stereoscopic image sheet 30 mounted to the advertisement medium main body 40.

The advertisement medium main body 40 includes a stereoscopic image display portion 12 and a spectacles portion 13 for viewing the stereoscopic image display portion 12, the stereoscopic image display portion 12 and the spectacles portion 13 are formed at both end portions in a length direction of one sheet of a plate-like member 14, the plate-like member 14 is formed to be able to arrange both end portions 15, 16 opposedly to each other by folding to bend to erect orthogonally to a middle portion 17.

According to the embodiment, the stereoscopic image display portion 12 is formed by thick paper, as shown by FIG. 1, the stereoscopic image display portion 12 is attachably and detachably fixed with the stereoscopic image sheet 30 displayed with a hole stereoscopic photograph 18 showing a scenery of viewing a specific hole of a certain golf course from a visual point of a player, and a hole perspective view 19 showing a layout of a total of the hole arranged on a right side of the hole stereoscopic photograph 18.

The stereoscopic image sheet 30 is formed by a laterally prolonged rectangular shape as a whole, 18 sheets thereof are provided in correspondence with all of 18 holes and are formed interchangeably to each other.

The stereoscopic image sheet 30 is fixed onto the stereoscopic image display portion 12 by attachably and detachably locking four corner portions thereof by fixing slits 31 provided at 4 portions formed at a surface portion of the stereoscopic image display portion 12.

The hole stereoscopic photograph 18 displayed at the stereoscopic image display portion 12 is formed to be able to optically recognize undulations of a ground surface of a green in the hole.

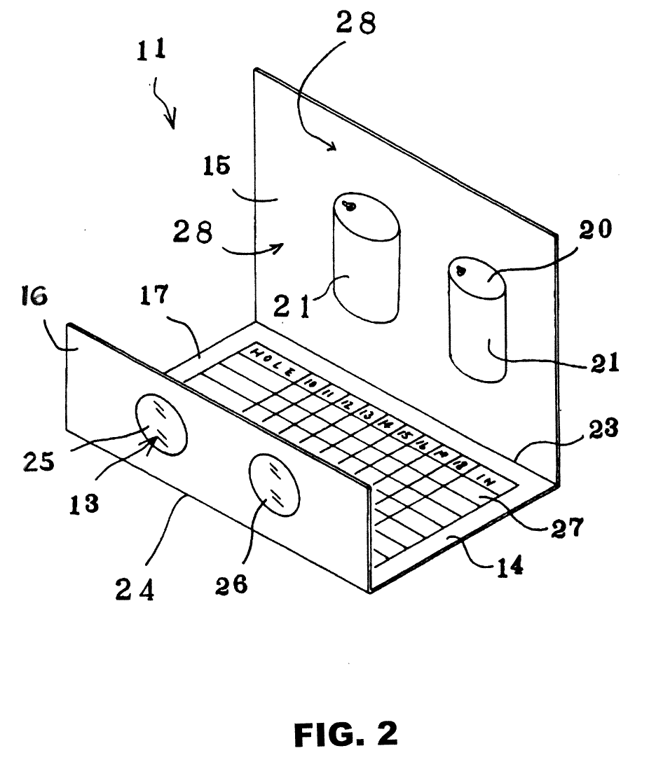

Further, as shown by FIG. 2, a back face side of the stereoscopic image display portion 12 is printed with a photograph 21 of a commodity of a sponsor of the golf tournament.

Further, as shown by FIG. 1 and FIG. 2, the middle portion 17 of the plate-like member 14 is displayed with score cards 22, 27 of golf on a surface side and a back face side thereof.

Further, the plate-like member 14 is formed to be able to be mailed as a mail by itself.

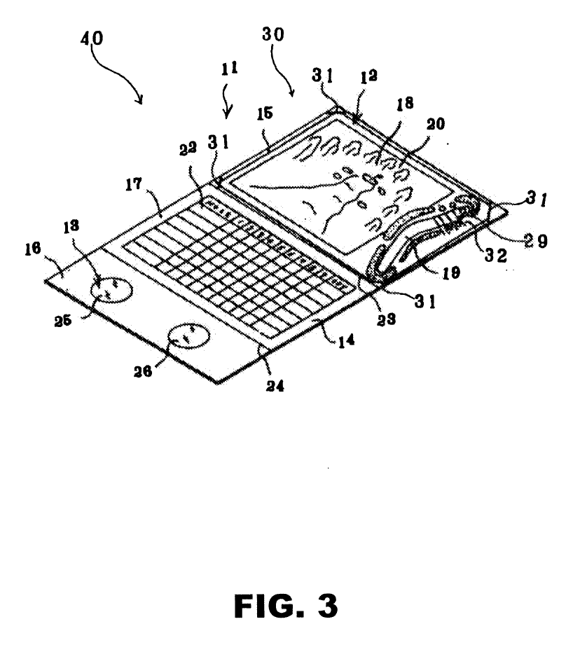

As shown by FIG. 3, the advertisement medium 11 according to the embodiment is constituted by a mode of one sheet of rectangular thick paper in a developed state, and is provided to a visitor of the golf tournament as a kind of a novelty in exchange for a viewing fee.

Therefore, the advertisement medium 11 is foldably formed and folded portions thereof are previously formed with fold streaks 23, 24.

The stereoscopic image display portion 12 is displayed with the hole stereoscopic photograph 18 showing sceneries of viewing greens from visual points of players respectively from positions of players in carrying out shots of respective holes of a certain golf course. The hole stereoscopic photograph 18 is displayed with a photograph of a scenery viewing in a direction of a green from a shot point.

The hole stereoscopic photograph 18 is formed as a stereoscopic jump-out image by taking the image of each hole by 4 pieces of cameras and further subjecting the image to a computer graphics. That is, the stereoscopic photograph 18 is displayed with an image viewed by a viewing angle of the right eye and an image viewed by a viewing angle of the left eye to overlap each other.

Further, the hole stereoscopic photograph 18 shows undulations of a ground surface of a green of the hole to be able to clearly recognize.

The right side of the hole stereoscopic photograph 18 is displayed with the hole perspective view 19 showing the layout of the total of the hole as shown by FIG. 1.

The hole perspective view 19 is described with a plurality of pieces of lines 29 showing fly distances. The plurality of pieces of lines 29 show fly distances of shots by remarkable professional golfers who played at the hole in the past, and right sides of the lines 29 are described with names 32 of respective remarkable professional golfers in correspondence with the respective lines.

Further, the hole perspective view 19 is formed to be able to be described by a ballpoint pen or the like and it can be recorded to which place a ball flies by how many shots.

On the other hand, the spectacles portion 13 is arranged with a lens 25 for the left eye and a lens 26 for the right eye by an interval dimension to be able to adopt an interval of the eyes of general Japanese. The lenses 25, 26 are constituted to be able to be used similarly even when reversed to the back face side as described below.

There is constructed a constitution in which only the image viewed by the viewing angle of the left eye can be viewed by the lens 25 for the left eye and only the image viewed by the viewing angle of the right eye can be viewed by the lens 26 for the right eye. Thereby, the hole stereoscopic photograph 18 is optically recognized as a stereoscopic image when viewed through the lens 25 for the left eye and the lens 26 for the right eye of the spectacles portion 13.

Further, the middle portion 17 of the plate-like member 14 is displayed with the score cards 22, 27 of golf on the surface and the rear face as shown by FIGS. 1 and 2.

That is, an upper face portion of the middle portion 17 of the plate-like member 14 is displayed with the score card 22 from No. 1 hole through No. 9 hole, and a back face portion of the middle portion 17 of the plate-like member 14 is displayed with the score card 27 from No. 10 hole to No. 18 hole.

Further, as shown by FIG. 2, the back face side of the stereoscopic image display portion 12 is formed with an advertisement display portion 28, for example, when the advertisement medium 11 is distributed to visitors as a souvenir of the golf tournament, the advertisement display portion 28 is described with the photograph 21 of the commodity of the sponsor enterprise of the golf tournament.

As the photograph 21 of the commodity of the sponsor, for example, when the sponsor is a drink maker, photographs of various drinks are formed by stereoscopic photographs as so-to-speak 3D images in which stereoscopic products by taking images of the products by 4 pieces of cameras and subjecting the images to a computer graphics are looked to jump out similar to the above-described image.

An explanation will be given as follows of operation of the golf goods 11 according to the embodiment based on a using method thereof.

The advertisement medium 11 according to the embodiment is distributed free of charge to participants of a golf competition by inviting the participants, or a gallery of a tournament to which famous golf players participate in exchange for an admission fee at a golf course.

When the gallery receiving the advertisement medium 11 uses the medium, the both end portions 15, 16 of one sheet of the plate-like member in the developed state shown in FIG. 3 are opposed to each other by being folded to bend to erect orthogonally to the middle portion 17 to form the stereoscopic image display portion 12 and the spectacles portion 13 to be able to view the stereoscopic photograph 18 fixed to the stereoscopic image display portion 12 through the spectacles portion 13.

The stereoscopic image display portion 12 is displayed with the hole stereoscopic photograph 18 showing a scenery of viewing a green from a shot position by a visual point of a player in a specific hole of a certain golf course, and therefore, an actual hole can visually be imaged, and the image of the hole can simulatingly experienced by a feeling of playing at the hole of the course as if in reality.

In this case, the hole stereoscopic photograph 18 is formed as the stereoscopic photograph subjected to computer graphics processing, and therefore, the hole can simulatingly be experienced by a virtual image by a further real image.

Further, the stereoscopic image display portion 12 is displayed with the hole perspective view 19 showing the layout of the total of the hole along with the hole stereoscopic photograph 18, and therefore, it can be investigated how to shoot a ball by what line of ball, to which point of the hole, and by what shot and by what degree of fly distance, and a method of attacking the hole can be investigated along with a professional of the tournament by taking a view of the tournament.

Further, in this case, the hole perspective view 19 is described with the line 29 indicating a shot arrival position attached with a name of a famous professional golfer, and therefore, the method of attacking the hole can be conceived by oneself in reference to the line 29.

Therefore, when a tournament is viewed as a gallery, the tournament can be viewed by comparing a shot of a playing professional with a shot of other famous professional, and therefore, the tournament can further be enjoyed to view.

Further, the advertisement display portion 28 on the back face side of the stereoscopic image display portion 12 is displayed with the photograph 2 of the commodity of the sponsor enterprise of the tournament and can optically be recognized as the stereoscopic and impressive 3D image by the image of jumping out the commodity of the sponsor through the spectacles portion 13, and therefore, the advertisement effect can be enhanced.

Further, the middle portion 17 of the plate-like member 14 is displayed with the score cards 22, 27 of golf, and therefore, when the golf tournament is viewed, while going along a professional golfer for whom the oneself is a fan, the score of the play can be recognized, and the taste of the tournament is enhanced.

Although according to the embodiment, an explanation has been given by taking an example of a case of distributing the advertisement medium 11 to a gallery in exchange for a viewing fee of a golf tournament, the invention is not limited to the embodiment but, for example, the advertisement medium 11 may be sold to a golfer with a charge at a sale store or the like of a golf course as a golf training good such that a general golfer can use the advertisement medium 11 for one's own play.

When the advertisement medium 11 is used for a play of a general golfer in this way, one's own scores can be described to the score cards 22, 27, and therefore, a score card installed at a golf course is dispensed with.

When the advertisement medium 11 according to the invention is used as the golf training good of one's own in this way, the stereoscopic image display portion 12 is displayed with the hole stereoscopic photograph 18 showing the scenery of viewing the green from the shot position by the visual point of the player in a specific hole of a certain golf course, and therefore, the actual hole can visually be imaged and the image of the hole can simulatingly experienced by a feeling of playing at the hole of a course as if in reality.

In this case, the hole stereoscopic photograph 18 is formed as a stereoscopic photograph subjected to the computer graphics processing, and therefore, the hole can simulatingly be experienced by a further virtual image by a further real image.

Further, the stereoscopic image display portion 12 is displayed with the hole perspective view 19 showing the layout of the total of the hole along with the hole stereoscopic photograph 18, and therefore, it can be investigated how a ball is to be shot by what line of the ball, to which place of the hole, by what shot and by what degree of a fly distance, and the method of attacking the hole can be investigated and grasped.

Further, in this case, the hole perspective view 19 is described with the line 29 indicating the shot arrival position of the famous professional golfer, and therefore, the method of attacking the hole can be conceived beforehand before going to the course by oneself while in reference to the line 29. Further, one's own shot can be studied by comparing the fly distance of the professional golfer and the fly distance of the one's own shot in reference to the display of the name of the famous professional golfer.

Therefore, according to the advertisement medium 11 according to the embodiment, it can be repeatedly investigated and confirmed how the shot is to be carried out by what line of ball, by what shot and by what angle on the hole, and therefore, when going out to the course and carrying out shots at respective holes, shots with self-confidence based on one's own investigation can swiftly be carried out.

Further, the hole can be viewed stereoscopically by the hole stereoscopic photograph 18 displayed on the stereoscopic image display portion 12, and therefore, undulations on the green can excellently be recognized. Thereby, a reality feeling of the hole is enhanced, a further complete image training can be carried out, which can be made to be in full use in an actual play, and therefore, the score can further easily be improved.

Further, the image displayed on the stereoscopic image display portion is formed attachably and detachably to and from the plate-like member 14, images of 18 holes are provided and formed to be able to be interchanged by each other, and therefore, the image training can be carried out by simulatingly experiencing all of the holes of the golf course.

Further, the plate-like member 14 may be formed to be able to be used as a picture postcard. In this case, the plate-like member 14 can be formed by a size the same as that of a postcard, instead of displaying the photograph 21 of the commodity of the sponsor on the back face side of the stereoscopic image display portion 12, the portion may be made to be blank to be able to describe an address, an item of conveyance or the like.

Further, when the plate-like member 14 is formed as a postcard which can be mailed, in a case in which an excellent score is achieved in one's own golf play, the postcard can be mailed to a friend, a family or the like as a souvenir by describing the score.

Further, the plate-like member 14 can be used as a souvenir capable of informing an atmosphere of a golf tournament or the like further really to a friend or a family and a record at a golf course with regard to a result of a tournament of a professional golfer for whom a friend or the like is a fan can be mailed to the friend or the like as a souvenir.

By providing the advertisement medium 11 by an individual who first obtains the advertisement medium 11 to other individual, receivers of advertisement information can further be increased, and the advertisement effect can further naturally be enhanced.

Although an explanation has been given by taking an example of a case in which the advertisement medium 11 according to the embodiment is used as a golf good distributed to a viewer of a tournament of a golf in exchange for a fee, the invention is not limited to the above-described embodiment but a golfer can use the advertisement medium 11 for an image training of one's own play, and when used in this way, the following effect is achieved.

That is, although it is general that a golf player carries out a practice for confirming a shot or a form in a golf training place before going out to a golf course actually, there is frequently the golf training place of so-to-speak ‘free shooting’ type, a golf course is not formed as in an actual golf course, and therefore, a training from a view point of how to attack respective holes of a golf course cannot be carried out.

Therefore, when a professional golfer actually stands at respective holes of a golf course, in a case in which the golf course is a course first for the professional golfer, a specific geographic situation of respective holes cannot sufficiently be grasped beforehand, and therefore, it cannot be investigated beforehand to which place of a course, a ball is to be shot by what angle and by what degree of fly distance.

As a result, when actually played, there is frequently a case in which the golfer goes out to the hole, and is obliged to determine with regard to a directionality of the shot, an angle of the shot, a fly distance or the like within a short period of time until carrying out the shot, as a result, there is frequently a case in which an excellent result cannot be achieved and it is difficult to improve the score.

Therefore, there is requested a golf training apparatus capable of virtually and preliminary experiencing respective holes of the golf course previously before actually going to the golf course and carrying out an image training with regard to a direction, an angle, a fly distance or the like of an effective shot in a related art, and the advertisement medium 11 according to the invention can meet the request by such a using method.

Further, although according to the embodiment, an explanation has been given by taking an example of a case in which an advertisement medium is distributed to a viewer of a tournament of a golf in exchange for a fee, the invention is not limited to the embodiment but, for example, in an event pavilion of a motor show or the like, an exhibiting enterprise can process a new model vehicle of its own company as a jump-out image to advertise by an impressive 3D image.

In such a case, the advertisement medium is distributed to visitors at the pavilion of the motor show.

In such a case, for example, a set of a plurality of sheets of a plurality of kinds of new model vehicles can be distributed along with the advertisement medium main body under a pretext of introduction of a list of new vehicles of the automobile enterprise of the year, visitors to the pavilion are persons interested in automobiles of the automobile enterprise, sales promotion can be carried out for the persons, and therefore, the advertisement medium constitutes a very effective advertisement having an excellent advertisement efficiency for the automobile enterprise.

Further, at a sales shop of a famous sightseeing cite, an image of a famous scenery at the sightseeing cite can be constituted by an impressive 3D image as a jump-out image to be sold at a souvenir shop along with the advertisement medium main body by constituting a set of a plurality of sheets thereof.

Further, activities of famous players in various conference items in the Olympic can be constituted by 3D images as jump-out images to be sold along with the advertisement medium main body by constituting a set of a plurality of sheets thereof.

Further, for example, at a karaoke house, a karaoke snack bar or the like, the advertisement medium according to the invention can also be used as an advertisement medium of sales promotion of a new singer, or promotion of a new musical composition.

When the advertisement medium according to the invention is used as sales promotion of a new musical composition or promotion of a new singer in this way, an image of a new singer or a singer constituting an object of sales promotion is subjected to stereoscopic image processing to be displayed on the stereoscopic image display portion 12 as a 3D image, the text of the new musical composition and a call number of a karaoke machine with regard to the new musical composition or a new musical composition intended to promote are displayed on the middle portion 17 of the plate-like member 14.

The advertisement medium 11 formed in this way is distributed to a customer along with a room key at, for example, a reception of the karaoke house free of charge, or distributed pertinently to a customer of a snack bar or the like free of charge.

The customer delivered with the advertisement medium 11 can clearly recognize a singer by looking at a stereoscopic image of the singer displayed on the stereoscopic image display portion 12 from the spectacles portion 13, further, a karaoke musical composition can be selected in reference to the call number of the karaoke musical composition displayed on the middle portion 17, further, the customer can sing while looking at the text of the musical composition similarly described on the middle portion 17.

When the advertisement medium 11 according to the invention is utilized for sales promotion of the new musical composition in this way, the singer can be recognized by the stereoscopic image, the customer can sing the musical composition according to the sales promotion easily by calling the musical composition by the karaoke machine based on the described call number, and therefore, similar to the cases of the respective embodiments, the sales promotion of the new musical composition or the like can effectively be carried out by way of the karaoke under a situation in which a person in need, a customer side directly faces an advertiser completely, or a situation of so-to-speak ‘one-to-one’ (1 versus 1).

As a result, very effective sales promotion of a new singer or a new musical composition can be carried out.

Although according to the invention, an explanation has been given by taking the example of a case in which the advertisement medium main body 40 is formed by thick paper, the invention is not limited to the embodiment but, for example, the advertisement medium main body 40 may be formed by a synthetic resin, and the advertisement medium main body 40 may be formed by a weight and a size which can ordinarily be used by respective individuals who are receivers of information.

Further, a specific shape of the advertisement medium main body 40 is not limited to the above-described embodiment.

The advertisement medium according to the invention is applicable to all of media providing advertisement information to individuals who are interested in the advertisement information directly by a stereoscopic image without utilizing mass media.

1-13. (canceled)

14. An advertisement medium comprising a stereoscopic image display portion capable of displaying a piece of advertisement information, and a spectacles portion capable of optically recognizing stereoscopically an image displayed on the stereoscopic image display portion for being provided to respective individuals who are receivers of the advertisement information.

15. The advertisement medium according to claim 14, wherein the advertisement medium is formed by a size capable of being distributed to the respective individuals who are the receivers of the piece of information and a weight capable of ordinarily being used by the respective individuals and formed foldably.

16. The advertisement medium according to claim 14, wherein the advertisement medium per se is formed to be able to be sent by mail.

17. The advertisement medium according to claim 14, wherein the advertisement medium comprises an advertisement medium main body and a stereoscopic image sheet displayed on the stereoscopic image display portion of an advertisement medium main body.

18. The advertisement medium according to claim 17, wherein the stereoscopic image sheet comprises a plurality of sheets and is fixed to the stereoscopic image display portion attachably thereto and detachably therefrom.

19. The advertisement medium according to claim 14, wherein the stereoscopic image display portion and the spectacles portion are provided at one sheet of a plate-like member and the stereoscopic image display portion and the spectacles portion are folded to be erected and used by being arranged to be able to be opposed to each other.

20. The advertisement medium according to claim 19, wherein a total of the plate-like member is formed by a rectangular shape and the stereoscopic image display portion and the spectacles portion are arranged at both end portion in a length direction thereof.

21. The advertisement medium according to claim 20, wherein the stereoscopic image display portions are formed at both of a surface side and a rear face side of the plate-like member and the stereoscopic image display portion and the spectacles portion are constituted to be able to be used even when the stereoscopic image display portion and the spectacles portion are folded to bend in a direction of the rear face.

22. The advertisement medium according to claim 21, wherein the stereoscopic image display portion is displayed with a hole stereoscopic photograph showing sceneries of viewing greens of respective holes of a golf course from a visual point of a player and hole perspective views showing layouts of the holes in correspondence with each other.

23. The advertisement medium according to claim 21, wherein a golf score card is displayed between the stereoscopic image display portion and the spectacles portion.

24. The advertisement medium according to claim 22, wherein the hole perspective view shows fly distances in the hole of respective professional golfers.

25. The advertisement medium according to claim 22, wherein the hole stereoscopic photograph displayed on the stereoscopic image display portion is formed to be able to optically recognize an undulation of a ground surface of the green of the photographed hole.

26. The advertisement medium according to claim 22, wherein the hole stereoscopic photographs and the hole perspective views displayed on the stereoscopic image display portion are formed by 18 sheets of photographs by individually taking images of 18 holes forming the golf course and are fixed to the stereoscopic image display portion attachably thereto and detachably therefrom.
